(19) United States
(12) Patent Application Publication
(10) Pub. No.: US 2026/0243664 A1
(43) Pub. Date: Aug. 20, 2026

(54) CONCENTRATION MEASUREMENT DEVICE AND METHOD FOR DETECTING ABNORMALITY IN SAME

(71) Applicant: FUJIKIN INCORPORATED, Osaka (JP)

(72) Inventors: Kazuteru TANAKA, Osaka-shi (JP); Masaaki NAGASE, Osaka-shi (JP); Kosuke SUGIMOTO, Osaka-shi (JP)

(73) Assignee: FUJIKIN INCORPORATED, Osaka (JP)

(21) Appl. No.: 18/992,801

(22) PCT Filed: Jun. 21, 2023
(86) PCT No.: PCT/JP2023/022881

§ 371 Date: Jan. 9, 2025

(30) Foreign Application Priority Data
Jul. 19, 2022 (JP) 2022-114558

(51) Int. Cl. G01N 21/33

(52) U.S. Cl. CPC G01N 21/33; G01N 2201/08; G01N 2201/12

(57) ABSTRACT

The concentration measurement device 100 comprises: an electrical unit 20 including a light source 22 having a plurality of light emitting elements LED1, LED2 for emitting lights of mutually different wavelengths and a photodetector 241; a fluid unit 10 having a measurement cell 1; a transmission member 15 connecting the electrical unit and the fluid unit; and a control circuit 28 connected to the light source and the photodetector. The concentration measurement device is configured to detect existence of an abnormality in an optical system including the light source, the transmission member, and the photodetector based on an intensity of the light emitted from the plurality of light emitting elements and an output of the photodetector.

### TECHNICAL FIELD

The present invention relates to a concentration measurement device and an abnormality detection method thereof, and more particularly, to a concentration measurement device for measuring a concentration of a fluid based on an intensity of a light passing through a fluid in a measurement cell, and an abnormality detection method thereof.

### BACKGROUND ART

Conventionally, a concentration measurement device (so called in-line type concentration measurement device) incorporated in a gas supply line for supplying a source gas formed of a liquid material or a solid material such as an organometal (MO) to semiconductor manufacturing equipment and configured to measure a concentration of the gas flowing through the gas supply line is well known.

In this type of concentration measurement device, a light having a predetermined wavelength from a light source is incident on a measurement cell for flowing the gas through a light incident window, and transmitted light passing through the measurement cell is received by a light receiving element, thereby an absorbance is measured. Further, the concentration of the gas in the measurement cell can be determined from the measured absorbance according to the Lambert-Beer law (for example, Patent Literatures 1 to 3).

In this specification, various transmitted light detection structures used to detect fluid concentration are broadly referred to as measurement cells. The measurement cell includes not only a separately provided measurement cell branched from a fluid supply line, but also an in-line type transmitted light detection structure provided in the middle of a fluid supply line as shown in Patent Literatures 1 to 3.

### RELATED-ART DOCUMENT

### Patent Documents

[Patent Literature 1] International Publication No. WO2021/054097
[Patent Literature 2] International Publication No. WO2020/213385
[Patent Literature 3] International Publication No. WO2018/021311

### SUMMARY OF INVENTION

### Technical Problem

Among in-line concentration measuring devices, there is one consisting of a measurement cell integrated into the fluid supply line and an electrical unit arranged at a distance from the measurement cell. Even when the measurement cell is heated to a high temperature (e.g., 150° C.), occurrence of damage or malfunction due to heat can be prevented by installing an optical element or a circuit element which has low resistance to high temperature in the electrical unit.

In the above configuration, the measurement cell and the electrical unit are connected to each other via an optical cable (optical fiber cable) or an electrical cable. In the concentration measurement device described in Patent Literatures 1 and 2, in order to form an optical system, two optical cables are used: one optical cable for guiding the light from the light source from the electrical unit to the measurement cell; and one optical cable for guiding the detection light that has passed through the measurement cell to the electrical unit. Patent Literature 3 discloses an aspect in which incident light and emitting light are transmitted using a common single optical cable in a reflection type concentration measurement device.

The optical cable is connected, for example, by fixing an optical connector provided at an end of the cable to an adapter attached to a casing of the electrical unit by a screw fastening method or the like. In the case of using two optical cables as described above, the connector of each optical fiber cable is detachably fixed to each of the adapters for the light from the light source and the adapter for the detection light provided in the electrical unit.

However, in this type of concentration measurement device, abnormality may occur in the optical path of the optical system due to unintentional disconnection of the connector or damage of the optical cable. When an ultraviolet light (for example, near-ultraviolet light having a wavelength of 200-400 nm) is used as the light from the light source for measuring the concentration of an organometallic gas or the like, the ultraviolet light may leak out of the device from the point where the abnormality occurred. Since ultraviolet light is harmful to the human body, it is not supposed to leak to the outside.

When the concentration measurement device is subjected to a reliability test or the like, the electrical unit may be detached and removed, so the attachment and detachment of the connector is not only performed at the time of the initial installation but also thereafter. In addition, even during usage, it is conceivable that the optical cable is artificially disconnected while the light source is turned on by accident, or the optical fiber may be broken or damaged.

Therefore, it is required to prevent the user from using the concentration measurement device without noticing that the ultraviolet light is leaking to the outside. For this reason, it is advantageous to be able to detect the occurrence of an abnormality in the optical system of the concentration measurement device at an arbitrary timing. In addition, even when a light other than ultraviolet light is used, it is advantageous to be able to easily detect the occurrence of an abnormality in the optical system at an early stage to appropriately perform concentration measurement.

The present invention has been made in view of the above problems, and a main object thereof is to provide a concentration measurement device, and an abnormality detection method for a concentration measurement device that is configured to be able to detect an occurrence of an abnormality in an optical system.

### Solution to Problem

The concentration measurement device according to an embodiment of the present invention comprises: an electrical unit including a light source having a plurality of light emitting elements for emitting light of mutually different wavelengths and a photodetector; a fluid unit having a measurement cell; a transmission member connecting the electrical unit and the fluid unit; and a control circuit connected to the light source and the photodetector. The concentration measurement device is configured to measure a concentration of a fluid in the measurement cell by using the photodetector to detect light incident from the light source into the measurement cell and emitted from the measurement cell, and the control circuit is configured to detect existence of an abnormality in an optical system including the light source, the transmission member, and the photodetector based on an intensity of a light emitted from the plurality of light emitting elements and an output of the photodetector.

In an embodiment, the concentration measurement device is configured to turn off the plurality of light emitting elements and issue an alert to the user when an occurrence of an abnormality is determined in the optical system.

In an embodiment, at least one of the lights emitted by the plurality of light emitting elements is ultraviolet light having a wavelength of 200-400 nm.

In an embodiment, the electrical unit further includes a reference photodetector for receiving a portion of the light from the light source before the light is incident on the transmission member, and the control circuit is configured to detect existence of an abnormality based on an intensity of a light emitted from the plurality of light emitting elements, an output of the photodetector, and an output of the reference photodetector.

In an embodiment, the light source includes two light emitting elements, one of the two light emitting elements is arranged to face the reference photodetector with a half mirror disposed in an inclined manner and sandwiched therebetween, and the other one of the two light emitting elements is arranged to face the half mirror but not to face the reference photodetector.

In an embodiment, the transmission member includes a first optical fiber cable for guiding the light from the light source to the measurement cell, and a second optical fiber cable for guiding the light emitted from the measurement cell to the photodetector.

The abnormality detection method for the concentration measurement device according to an embodiment of the present invention comprises an electrical unit including a light source having a plurality of light emitting elements for emitting lights of different wavelengths and a photodetector; a fluid unit having a measurement cell, a transmission member connecting the electrical unit and the fluid unit; and a control circuit connected to the light source and the photodetector. The concentration measurement device is configured to measure a concentration of a fluid in the measurement cell by using the photodetector to detect the light being incident from the light source into the measurement cell and emitted from the measurement cell. The abnormality detection method for the concentration measurement device comprises: a step of emitting lights of different wavelengths from the plurality of light emitting elements; a step of measuring an intensity of the light received by the photodetector; and a step of detecting existence of an abnormality in the optical system including the light source, the transmission member, and the photodetector by comparing the intensity of the light emitted from the plurality of light emitting elements with the intensity of the light received by the photodetector.

In an embodiment, the light source is constituted by two light emitting elements of a first light emitting element and a second light emitting element; the electrical unit further includes a reference photodetector for receiving a part of the light from the plurality of light emitting elements before the light is incident on the transmission member, and the abnormality detection method further includes: a step of determining an occurrence of an optical attenuation abnormality, when a result obtained by subtracting a light intensity of the first light emitting element from a light intensity of the first light emitting element detected by the photodetector, and a result obtained by subtracting a light intensity of the second light emitting element from the light intensity of the second light emitting detected by the photodetector is equal to or less than a threshold value; also when a result obtained by subtracting the light intensity of the first light emitting element from a light intensity of the first light emitting element detected by the reference photodetector and a result obtained by subtracting the light intensity of the second light emitting element from the light intensity of the second light emitting element detected by the photodetector is equal to or less than a threshold value; a step of determining an occurrence of an abnormality in the photodetector when a result obtained by subtracting the light intensity of the first light emitting element from the light intensity of the first light emitting element detected by the photodetector is equal to or less than a threshold value, and a result obtained by subtracting the light intensity of the second light emitting element from the light intensity of the second light emitting element detected by the photodetector is equal to or less than a threshold value; a step of determining an occurrence of an abnormality in the first light emitting element when a result obtained by subtracting the light intensity of the first light emitting element from the light intensity of the first light detected by the photodetector is equal to or less than a threshold value, and a result obtained by subtracting the light intensity of the first light emitting element from the light intensity of the first light detected by the reference photodetector is equal to or less than a threshold value; a step of determining an occurrence of an abnormality in the second light emitting element, when a result obtained by subtracting the light intensity of the second light emitting element from the light intensity of the second light emitting element detected by the photodetector is equal to or less than a threshold value, and a result obtained by subtracting the light intensity of the second light emitting element from the light intensity of the second light emitting element detected by the reference photodetector is equal to or less than a threshold value; a step of determining an occurrence of an abnormality in the reference photodetector, when a result obtained by subtracting the light intensity of the first light emitting element from the light intensity of the first light emitting element detected by the reference photodetector is equal to or less than a threshold value, and a result obtained from subtracting the light intensity of the second light emitting element from the light intensity of the second light emitting element detected by the reference photodetector is equal to or less than a threshold value.

### Effect of Invention

According to the embodiments of the present invention, in the concentration measurement device in which the measurement cell and the electrical unit are provided separately, the occurrence of abnormality in the optical system can be detected by a relatively simple method, and when an abnormality is detected, the light source can be stopped to prevent light leakage to outside, and an alarm is issued to notify the user.

### BRIEF DESCRIPTION OF DRAWINGS

FIG. 1 is a schematic diagram illustrating an overall configuration of a concentration measurement device according to an embodiment of the present invention.

FIG. 2 are diagrams illustrating abnormality occurrence patterns in the optical system of the concentration measurement device. FIG. 2(a) indicates a state where the connector of the optical fiber cable on the photodetector side is detached, FIG. 2(b) indicates a state where the connector of the optical fiber cable on the light source side is detached.

FIG. 3 are diagrams illustrating abnormality occurrence patterns in the optical system of the concentration measurement device. FIG. 3(a) indicates a state where the optical fiber cable is disconnected, and FIG. 3(b) indicates a state such as an extreme contamination in the measurement cell or a failure occurrence of the reflective member.

FIG. 4 is a diagram showing a flowchart for performing the abnormality detection process of the optical system.

FIG. 5 is a diagram showing a flowchart for performing an abnormality detection process when the concentration measurement device is in operation.

FIG. 6 is a schematic diagram illustrating an overall configuration of the concentration measurement device in another embodiment.

### DESCRIPTION OF EMBODIMENTS

Embodiments of the present invention will be described below with reference to the drawings, but the present invention is not limited to the following embodiments. In addition, although a concentration measurement device using a gas as the measurement target is described below, the measurement target may be a fluid other than a gas, such as a liquid.

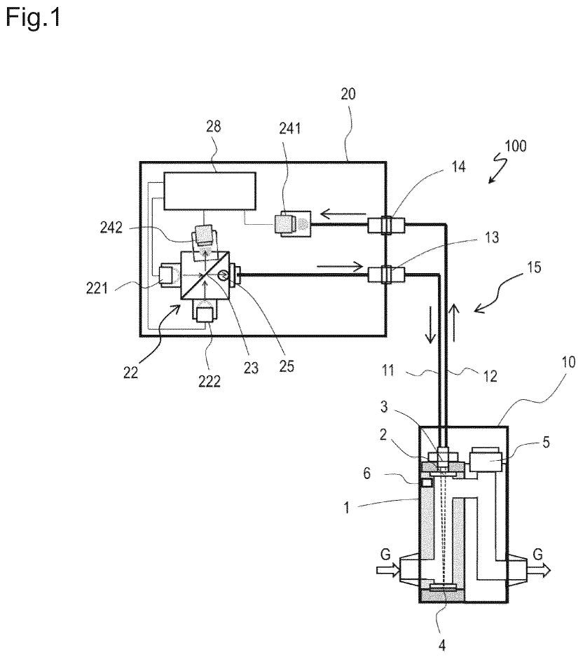

FIG. 1 is a diagram illustrating an overall configuration of a concentration measurement device 100 according to an embodiment of the present invention. The concentration measurement device 100 comprises a fluid unit 10 having a measurement cell 1 incorporated in a gas supply line, and an electrical unit 20 spaced apart from the fluid unit 10 and including a light source 22 and a photodetector (or light receiving element) 241.

The fluid unit 10 may be heated to, for example, about 100° C. to 150° C. depending on the type of the measurement gas, while the electrical unit 20 is usually maintained at room temperature. As a result, the circuit or the element provided in the electrical unit 20 is prevented from being damaged or malfunctioning due to heat. An external control device configured to transmit a control signal to the concentration measurement device 100 and to receive a measurement signal from the concentration measurement device 100 may be connected to the electrical unit 20.

The separated fluid unit 10 and the electrical unit 20 are optically and electrically connected by a first optical fiber cable 11 (hereinafter, sometimes referred to as first optical fiber 11), a second optical fiber cable 12 (hereinafter, sometimes referred to as second optical fiber 12), and a sensor cable (not shown). The first optical fiber 11 is connected to the light source 22 in the electrical unit 20 by an optical connector 13, and the second optical fiber 12 is connected to the photodetector 241 in the electrical unit 20 by an optical connector 14. As the optical connectors 13 and 14, for example, an FC connector may be used.

In the present specification, a member for optically connecting the fluid unit 10 and the electrical unit 20 may be collectively referred to as a transmission member 15. The transmission member 15 of the present embodiment includes a first optical fiber 11, a second optical fiber 12, and optical connectors 13 and 14. In the concentration measurement device 100, the first optical fiber 11 constituting the transmission member 15 is used for guiding the light from the light source 22 to a measurement cell 1, and the second optical fiber 12 is used for guiding the light emitted from the measurement cell 1 to the photodetector 241.

The fluid unit 10 incorporated in the gas supply line is provided with a measurement cell 1, a translucent or transparent window 2 in contact with the flow path (here, a translucent plate) is provided at one end of the measurement cell 1, and a reflective member 4 is provided at the other end of the measurement cell 1. In the fluid unit 10 through which a gas G flows, the measurement cell 1 is used as a part of the flow path and is also used as an optical path of the measurement light.

In the present embodiment, a so-called reflection type measurement cell having a reflective member 4 is used, in which light reciprocates in the measurement cell 1, but the present invention is not limited to this. In another embodiment, a so-called transmission type measurement cell may be used in which light is incident on one end of the measurement cell and light passing through the measurement cell is emitted from the other end (without a reflective member). In this case, the light from the light source and the transmission light are transmitted by separate optical fibers connected to both ends of the measurement cell respectively.

A collimator (or collimator lens) 3 connected with the optical fibers 11 and 12 is attached in the vicinity of the window 2 of the measurement cell 1. The collimator 3 is configured to cause the light from the light source to be incident on the measurement cell 1 as parallel light and to condense the reflected light from the reflective member 4 to cause the reflected light to be incident on the second optical fiber 12.

As the window 2, for example, a sapphire plate is used, and as the reflective member 4, for example, a sapphire plate having an aluminum layer or a dielectric multilayer film on the back surface as the reflective layer is used. The reflective surface of the reflective member 4 is provided so as to be perpendicular to the traveling direction of the incident light or the central axis of the measurement cell 1. It should be noted that the window 2 may be disposed at a slight angle (for example, 1° to) 5° from a plane perpendicular to the central axis of the measurement cell 1, thereby suppressing the influence of the surface reflected light on the measurement.

The fluid unit 10 of the present embodiment further includes a pressure sensor 5 for detecting the pressure of the measurement gas flowing in the measurement cell 1, and a temperature sensor 6 for measuring the temperature of the measurement gas. Outputs of the pressure sensor 5 and the temperature sensor 6 are sent to the electrical unit 20 via a sensor cable (not shown). The outputs of the pressure sensor 5 and the temperature sensor 6 may be used for measuring the concentration of the gas, as described below.

On the other hand, the electrical unit 20 includes a light source 22 for generating the incident light to the measurement cell 1, a photodetector 241 for receiving the emitted light from the measurement cell 1, and a control circuit 28 for calculating the concentration of the measurement gas based on a detection signal output from the photodetector 241 (a detection signal corresponding to the intensity of the received light).

In the present embodiment, the light source 22 is constituted by two light emitting elements (here, LED) of a first light emitting element 221 and a second light emitting element 222 for emitting lights having differing wavelengths. Driving currents of different frequencies are supplied to the first and the second light emitting elements 221 and 222 using an oscillation circuit, and the intensity of the light corresponding to each wavelength component can be measured from the detection signal detected by the photodetector 241 by performing frequency analysis (for example, fast Fourier transform, or wavelet transform). As the light emitting elements 221 and 222, an LD (laser diode) may be used in addition to LED.

The emission wavelengths of the first light emitting element 221 and the second light emitting element 222 may be arbitrarily set corresponding to the absorption wavelength band of the fluid to be measured. When measuring the concentration of various fluids that absorb near-ultraviolet light, the emission wavelength of the first light emitting element 221 is set to, for example, 280-320 nm, and the emission wavelength of the second light emitting element 222 is set to, for example, 340-380 nm. However, the present invention is not limited thereto, and the emission wavelengths of the respective elements may be appropriately selected depending on the application, for example, one element emits near-ultraviolet rays of 200-400 nm, while the other element emits near-infrared rays of 800-2000 nm that can be absorbed by water vapor. One or both elements may be elements that emit visible light. In the present specification, the term “light” includes not only visible light but also at least infrared rays and ultraviolet rays and may include electromagnetic waves of arbitrary wavelengths. The term “translucency” means that the internal transmittance with respect to the light incident to the measurement cell is sufficiently high to enable concentration measurement.

In the light source 22, the first and the second light emitting elements 221 and 222 are arranged so as to irradiate light on a half mirror 23 at an angle of 45°. Further, the reference photodetector 242 is provided to face the second light emitting element 222 with the half mirror 23 interposed therebetween. On the other hand, the first light emitting element 221 is disposed to face the half mirror 23, but not to face the reference photodetector 242.

In this configuration, a portion of the light emitted from the first light emitting element 221 and the second light emitting element 222 is incident on the reference photodetector 242 and is used to examine deterioration in the light emitting element, or the optical element, and the like. The remaining light is condensed by the ball lens 25 and then is incident on the optical fiber 11 as incident light. As the light receiving element of the photodetector 241 and the reference photodetector 242, for example, a photodiode or a phototransistor is used.

Although FIG. 1 shows an aspect in which the optical connector 13 and the ball lens 25 are connected to each other by an optical fiber, also the optical connector 14 and the photodetector 241 are connected to each other by an optical fiber, the present invention is not limited thereto. In the electrical unit 20, same as the concentration measurement device described in Patent Literature 2, the light source 22 and the optical connector 13 may be disposed adjacent to each other and may be directly connected to each other. In addition, the photodetector 241 and the optical connector 14 may be disposed adjacent to each other and may be directly connected to each other.

The control circuit 28 may be realized by a combination of hardware and software consisting of, for example, a processor, a memory, or the like, provided on a circuit board, and including a computer program for executing a predetermined operation based on an input signal. The control circuit 28 is connected to the first light emitting element 221, the second light emitting element 222, the photodetector 241, and the reference photodetector 242, and is configured to perform on-off control of the first and the second light emitting elements 221 and 222, calculation of the fluid concentration in the measurement cell based on the output of each photodetector 241 and 242, and detection of abnormality in the concentration measurement device 100 to be described later. In the aspect shown in the drawing, the processor 28 is incorporated in the electrical unit 20, but a part (such as a CPU) or all of the constituent elements thereof may be provided in a device outside the electrical unit 20.

Here, a concentration measurement method using the concentration measurement device 100 will be described. In the measurement cell 1, an optical path length L of the light reciprocating inside the measurement cell 1 can be defined by twice the distance between the window 2 and the reflective member 4. In the concentration measurement device 100, a light having a wavelength λ, which is incident on the measurement cell 1 and then reflected by the reflective member 4, is absorbed in accordance with the concentration of the gas in the cell. Then, the control circuit 28 can measure the absorbance Aλ at the wavelength λ by frequency-analyzing the detected signal from the photodetector 241, and can calculate the molar concentration Cₘ of the gas in the cell from the absorbance Aλ based on the Lambert-Beer law shown in the following equation.

$$A λ = - {log}_{10} ( I / {I}_{0} ) = {α}^{′} {LC}_{m}$$

In the above equation, I₀ is the intensity of the incident light to be incident on the measurement cell, 1 is the intensity of the light passing through the gas in the measurement cell, α′ is a molar extinction coefficient (m²/mol), L is the optical path length (m) of the measurement cell, and Cₘ is the molar concentration (mol/m³). The molar extinction coefficient α′ is a coefficient determined by the substance. Note that, with respect to the incident light intensity I₀ in the above equation, the intensity of the light detected by the photodetector 241 when there is no light-absorbing gas in the measurement cell 1 (for example, when a gas that does not absorb ultraviolet light is filled, or when the measurement cell is vacuumed) may be regarded as the incident light intensity I₀.

The concentration measurement device 100 may be configured to determine the concentration of the gas flowing through the measurement cell 1 with reference to the outputs of the pressure sensor S and the temperature sensor 6. As disclosed in Patent Literatures 1 and 2, when the Lambert-Beer equation is modified using the pressure and temperature of the gas, the following relational equation is obtained.

$${C}_{v} = ( RT / {α}_{a} LPt ) \cdot ln ( {I}_{0} / I )$$

In the above equation, Cv is the concentration (volume %) of the measurement gas in the total gas, αₐ is the extinction coefficient of the measurement gas, Pt is the total pressure that can be measured by the pressure sensor 5, T is the temperature that can be measured by the temperature sensor 6, and R is the gas constant. Similarly to Lambert-Beer law, L is the optical path length of the measurement cell, I₀ is the incident light intensity, and I is the transmitted light intensity.

As described above, the concentration measurement device 100 can determine the concentration of the fluid in the measurement cell 1 based on the output (transmitted light intensity I) of the photodetector 241. However, when an abnormality occurs in the optical system including the light source 22, the transmission member 15, and the measurement cell 1, it is difficult to measure the concentration appropriately. In particular, when ultraviolet rays are used as the measurement light, care must be taken to prevent the measurement light from leaking to the outside so as not to adversely affect the human body.

Therefore, the concentration measurement device 100 of the present embodiment is configured to be able to detect whether an abnormality has occurred in the optical system based on the outputs of the first light emitting element 221 and the second light emitting element 222, and the light receiving intensity of the photodetector 241.

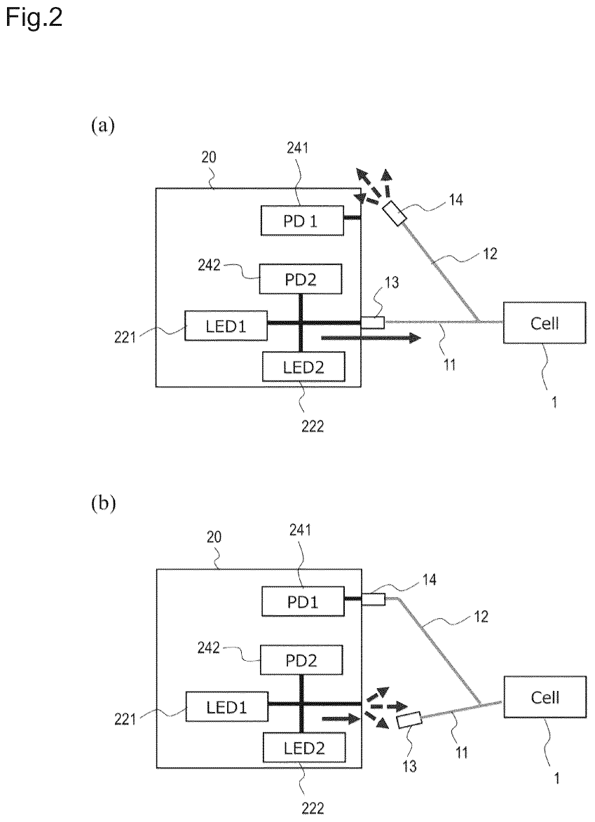

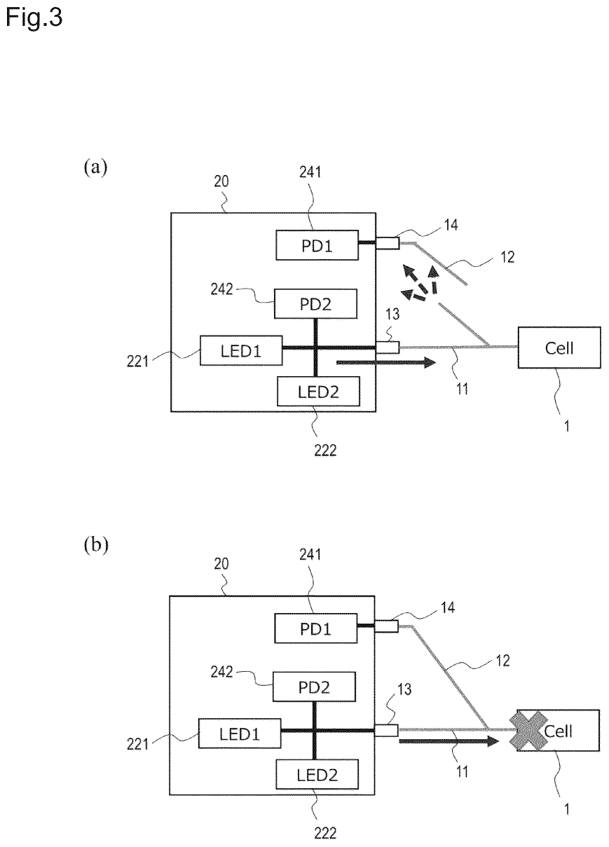

FIG. 2(a), FIG. 2(b), FIG. 3(a), and FIG. 3(b) are diagrams for explaining patterns of abnormality occurrence in the optical path of the optical system. Each drawing illustrates a different pattern of abnormality occurrence. In each drawing, the first light emitting element 221 is referred to as LED1, the second light emitting element 222 is referred to as LED2, the photodetector 241 is referred to as PD1, the reference photodetector 242 is referred to as PD2, and the measurement cell 1 is referred to as Cell.

First, as shown in FIG. 2(a), it is conceivable that, as a pattern 1, in the electrical unit 20, the connector 14 of the second optical fiber 12 for guiding the detection light that has reciprocated in the measurement cell 1 is detached. In this case, the detection light (for example, ultraviolet light) is exposed to the outside from the connector 14. The photodetector 241 then does not receive the light from the measurement cell 1 and the output thereof is typically zero.

Next, as shown in FIG. 2(b), it is conceivable that as a pattern 2, in the electrical unit 20, the connector 13 of the optical fiber 11 for guiding the light from the light source to the measurement cell 1 is detached. In this case, the light from the light source is exposed to the outside from an adapter connected to the connector 13. The photodetector 241 then does not receive light from the measurement cell 1 and the output is typically zero.

Next, as shown in FIG. 3(a), it is conceivable that as a pattern 3, the optical fiber 12 is broken halfway, which results in a disconnected state. In this case, the light from the light source is exposed to the outside from the damaged portion of the optical fiber 12. The same applies to a case where the optical fiber 11 for incident light is damaged instead of the optical fiber 12 for emitting light. The photodetector 241 then does not receive light from the measurement cell 1 and the output thereof is typically zero.

Next, as shown in FIG. 3(b), as a pattern 4, in the measurement cell 1, it is also conceivable that the detection light that has reciprocated the measurement cell 1 is not guided to the optical fiber 12 appropriately due to extreme dirt generated on the window 2, dirt on the reflective member 4, or changes of the inclination angle of the reflective surface. In this case, the photodetector 241 will not receive light that has sufficient intensity from the measurement cell 1, and the output thereof will be small, possibly zero.

In the case of any of the above abnormality occurrence patterns, it is difficult for the photodetector 241 to receive appropriate detection light. Therefore, by checking the output of the photodetector 241 in a state where both the first and the second light emitting elements 221 and 222 are caused to emit light, it is possible to detect whether an abnormality has occurred in the optical system as described above.

Here, the first light emitting element 221 and the second light emitting element 222 can emit light of different wavelengths. Further, the photodetector 241 can measure the intensity of the light emitted from each of the light emitting elements by frequency analysis of the detection signal. Therefore, by turning on both light emitting elements and measuring the intensity of the light from each of the light emitting elements in the photodetector 241, it is possible to appropriately determine whether an abnormality has occurred in the optical path of the optical system for the lights of at least two wavelengths.

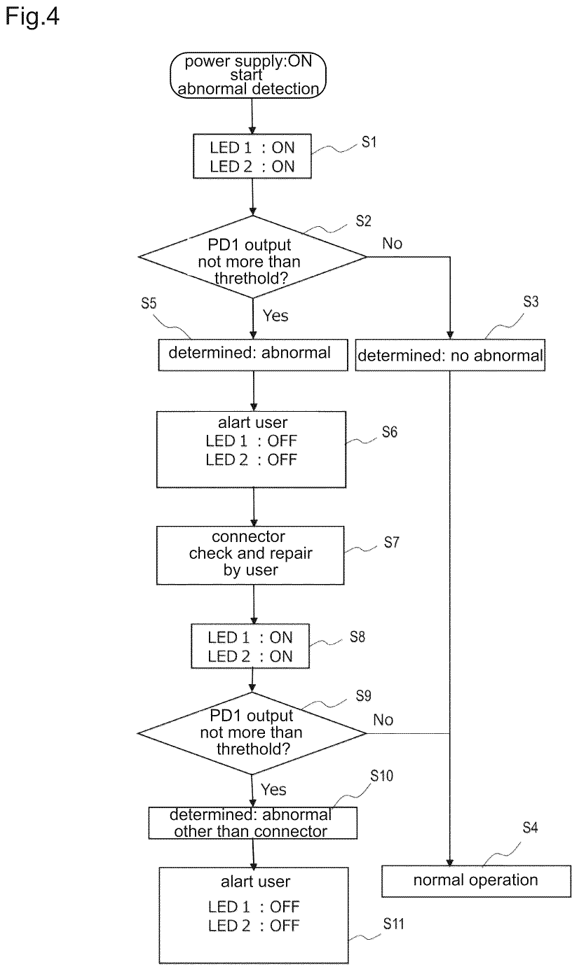

FIG. 4 is a flowchart illustrating an example of the abnormality detection process using the output of the photodetector 241. Here, a step in a case where abnormality detection is performed in advance at a time when staring the operation of the concentration measurement device 100 or the like will be described.

First, as shown in step S1, the first light emitting element 221 (LED1) and the second light emitting element 222 (LED2) are both turned on. Next, in step S2, it is determined whether the power of the photodetector 241 (PD1) is equal to or less than a threshold value. Here, the received light intensity of the light from the first light emitting element 221 and the received light intensity of the light from the second light emitting element 222 are detected from the outputs of the photodetector 241, and it is determined whether the respective received light intensity is equal to or less than a predetermined threshold value. The threshold value may be arbitrarily set, for example, a value added to zero by an assumption error or a half value of an output value when the normal light source is turned on.

In step S2, when the output of the photodetector (PD1) exceeds the threshold value (or is equal to or larger than the threshold value), as shown in step S3, it is determined that no abnormality has occurred in the optical system, the abnormality detection process is ended, and the process proceeds to the normal operation S4, i.e., the state where concentration measurement can be performed.

At this time, since whether the light from the two light emitting elements having different wavelengths reach the photodetector (PD1) is confirmed, for example, even if the light of one wavelength is unintentionally absorbed by the gas, but the light of the other wavelength sufficiently reaches, it can be determined that no abnormality has occurred in the optical system having the same optical path. However, in order to more reliably determine that no abnormality has occurred, it may be confirmed that the lights of both wavelengths have sufficiently reached the photodetector.

On the other hand, in step S2, when the output of PD1 is equal to or less than the threshold value (or less than the threshold value), it is determined that an abnormality has occurred in the optical path of the optical system as shown in step S5. Then, as shown in step S6, an alert is issued to the user, the first and the second light-emitting elements LED1, LED2 are typically automatically turned off. The alert to the user may be provided in any manner, such as by displaying on a display screen, issuing a warning sound or a warning light.

Here, as shown in step S7, the user who has received the alert can confirm whether the optical fiber is properly connected to the connector. At this time, since LED1 and LED2 are turned off in step S6, even if the connector is disconnected, the user is not exposed to UV light, and the operation can be safely performed. Further, in this step, the user can safely check whether an abnormality has occurred, such as disconnection of the optical fiber cable.

When the connector is completely disconnected or a connection failure is found, the connector is firmly fixed and repaired. When a disconnection is found, the cable is replaced, and repair work is performed. Thus, it is possible to eliminate the abnormality occurrence pattern as shown in FIG. 2(a), FIG. 2(b), and FIG. 3(a).

Next, as shown in step S8, after confirming and repairing the connection, the first light emitting element (LED1) and the second light emitting element (LED2) are turned on again in accordance with a user command, and a further abnormality detection step is performed.

Here, as shown in step S9, when the output of PD1 exceeds the threshold value (or is equal to or larger than the threshold value), it is determined that the abnormality in the optical system has been resolved by the restoration operation in step S7, and the process proceeds to the normal operation shown in step S4. The threshold value may be the same as or different from the threshold value used in step S2.

On the other hand, in step S9, when the output of PD1 is equal to or less than the threshold value (or less than the threshold value), as shown in step S10, it is determined that an abnormality other than the connector (or the optical fiber disconnection) has occurred, and as shown in step S11, an alert is issued to the user, the first and the second light emitting elements LED1, LED2 are typically automatically turned off.

In this case, the user can suspect that the abnormality has occurred not due to the occurrence of a defect that is easily visually recognized from the outside, such as connection failure or disconnection of the connector, but due to the extreme contamination on the light transmission member in the measurement cell 1, or the abnormal arrangement of the optical elements. In addition, the user may also suspect the defective element of the first light emitting element 221, the second light emitting element 222, or the photodetector 241 in the electrical unit 20. Of course, it is also conceivable that the connector or the optical fiber that has been repaired previously has not been properly repaired, and thus the repair work may be performed again.

In the abnormality detection process described above, any confirmation of an abnormality can be performed in a state where the first and second light emitting elements LED1, LED2 are turned off, which is safe, and by performing this process prior to the operation, it is possible to avoid continuous use of the device in a state where, for example, ultraviolet rays is leaking to the outside. In addition, since the abnormality detection process can be performed in a relatively simple short-time operation by using the elements included in the conventional concentration measurement device, the abnormality detection process can be stably performed while improving safety without increasing cost.

Hereinafter, an abnormality detection step of another aspect in which abnormality detection is performed in the electrical unit 20 using the outputs of not only the main photodetector 241, but also the reference photodetector 242 will be described.

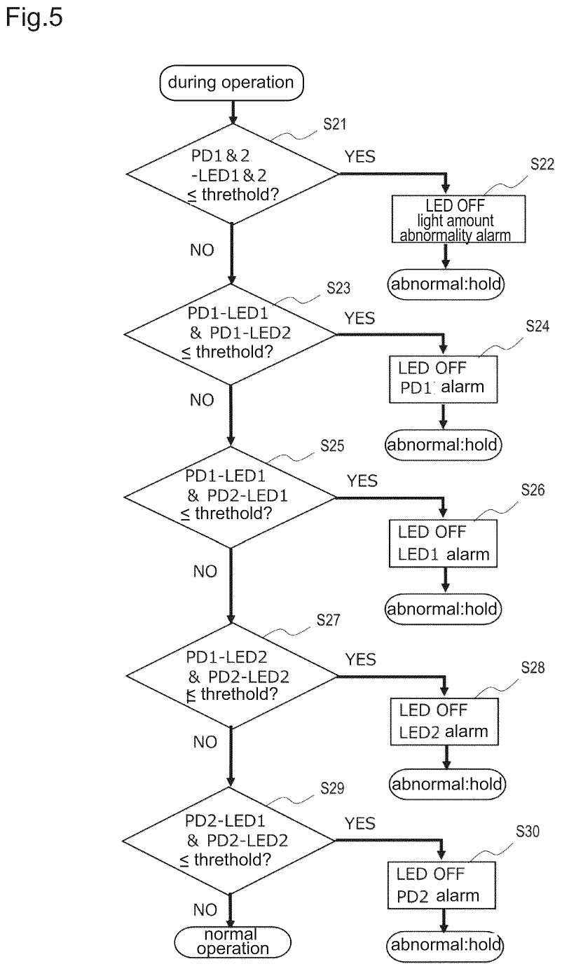

FIG. 5 is a flowchart of an abnormality detection process that can be performed at an arbitrary timing during the operation of the concentration measurement device 100. This abnormality detection process can be performed constantly or periodically concurrently with the concentration measurement process.

In FIG. 5, LED1 refers to the first light emitting element 221 or the light intensity thereof (a predetermined value that is set based on a preliminary measurement result or the like), LED2 refers to the second light emitting element 222 or the light intensity thereof (a predetermined value set based on a preliminary measurement result or the like), PD1 refers to the photodetector 241 or the output thereof, and PD2 refers to the reference photodetector 242 or the output thereof. Here, LED1 is an element emitting light having a wavelength that can be absorbed to some extent by the gas in the measurement cell 1, and LED2 is an element emitting light having a wavelength that cannot be absorbed in the measurement cell.

First, as shown in step S21, a value is obtained by subtracting the light intensities of the first and second light-emitting elements LED1 and LED2 from the light intensity detected by the photodetector (PD1). The photodetector (PD1) can measure the received light intensity of the light emitted from the light emitting element LED1 and the received light intensity of the light emitted from the light emitting element LED2 respectively by frequency analysis or the like. In addition, a value is obtained by subtracting the light intensities of the light emitting elements LED1 and LED2 from the light intensity detected by the reference photodetector (PD2). The reference photodetector (PD2) can also measure the received light intensity of the light emitted from the light emitting element LED1 and the received light intensity of the light emitted from the light emitting element LED2 respectively by frequency analysis or the like.

When both subtraction values are equal to or less than a threshold value, it is considered that an excessive strong attenuation of light in the optical path of the optical system has occurred. For this reason, in step S22, both LEDs are turned off, and an alert can be issued to notify the user that a light attenuation abnormality has occurred in the optical system (for example, an abnormality due to extreme contamination generated on the window or on the reflective member of the measurement cell). When an abnormality is detected, the subsequent operation is stopped, and the process proceeds to the hold state.

Here, it is also conceivable that the light from the first light emitting element LED1 is absorbed by the gas in the measurement cell 1, and consequently the light intensity of the photodetector PD1 greatly decreases due to the concentration of the gas and becomes equal to or less than the threshold value. By contrast, in the present embodiment, since the light intensity of the second light emitting element LED2, that is not absorbed by the gas, is also detected by the photodetector PD1 at the same time, it is possible to accurately detect the attenuation of the light that is not absorbed by the gas. As a result, an abnormality of the optical system can be detected more accurately.

Next, in step S23, it is determined that whether a value obtained by subtracting the light intensity of the light emitting element LED1 from the light intensity detected by the photodetector (PD1) is equal to or less than the threshold value, and whether a value obtained by subtracting the light intensity of the light emitting element LED2 from the light intensity detected by the photodetector (PD1) is equal to or less than the threshold value. Here, since it is considered that an abnormality has occurred in the photodetector (PD1) if both values are equal to or less than a threshold value, as shown in step S24, it is possible to issue an alert to notify the user that the abnormality has occurred in the photodetector (PD1) while turning off both LEDs. In addition, when the abnormality is detected, the subsequent operation is stopped, and the process proceeds to the hold state.

Further, in step S23, if it is determined that the lights of both the light emitting element LED1 and the light emitting element LED2 have not sufficiently reached the photodetector (PD1), it is considered that an abnormality has not occurred in the photodetector (PD1), as shown in FIG. 2(a), FIG. 2(b), and FIG. 3(a), there is also a possibility that the optical connector is dropped, or the optical fiber cable is disconnected. Therefore, in this case, the user can check the connector and the optical fiber cable and perform repair work as necessary.

Next, in step S25, it is determined whether a value obtained by subtracting the light intensity of the light emitting element LED1 from the light intensity detected by the photodetector (PD1) is equal to or less than the threshold value, and whether a value obtained by subtracting the light intensity of the light emitting element LED1 from the light intensity detected by the reference photodetector (PD2) is equal to or less than the threshold value. Here, if both values are below the threshold value, it is considered that an abnormality has occurred in the light emitting element LED1, and therefore, as shown in step S26, it is possible to issue an alert to notify the user that the abnormality has occurred in LED1. When the abnormality is detected, the subsequent operation is stopped, and the process proceeds to the hold state.

Next, in step S27, it is determined whether a value obtained by subtracting the light intensity of the light emitting element LED2 from the light intensity detected by the photodetector (PD1) is equal to or less than the threshold value, and whether a value obtained by subtracting the light intensity of the light emitting element LED2 from the light intensity detected by the reference photodetector (PD2) is equal to or less than the threshold value. Here, if both values are below the threshold value, it is considered that an abnormality has occurred in the light emitting element LED2, and therefore, as shown in step S28, it is possible to issue an alert to notify the user that the abnormality has occurred in LED2. When the abnormality is detected, the subsequent operation is stopped, and the process proceeds to the hold state.

Next, in step S29, it is determined whether a value obtained by subtracting the light intensity of the light emitting element LED1 from the light intensity detected by the reference photodetector (PD2) is equal to or less than the threshold values, and whether a value obtained by subtracting the light intensity of the light emitting element LED2 from the light intensity detected by the reference photodetector (PD2) is equal to or less than the threshold value. Here, if both values are below the threshold values, it is considered that an abnormality has occurred in the reference photodetector (PD2), as shown in step S30, it is possible to turn off both LEDs and issue an alert to notify the user that the abnormality has occurred in the reference photodetector (PD2). When the abnormality is detected, the subsequent operation is stopped, and the process proceeds to the hold state.

After all the above checks, when it is determined that no abnormality has occurred in the optical system, the normal operation can be continuously performed. In this way, even when the concentration measurement device 100 is in operation, it is possible to detect the abnormality in attenuation of the optical system and the abnormality in the light emitting element and the light receiving element. Further, since the cause of the abnormality can be confirmed, thus whether repair is possible can also be confirmed.

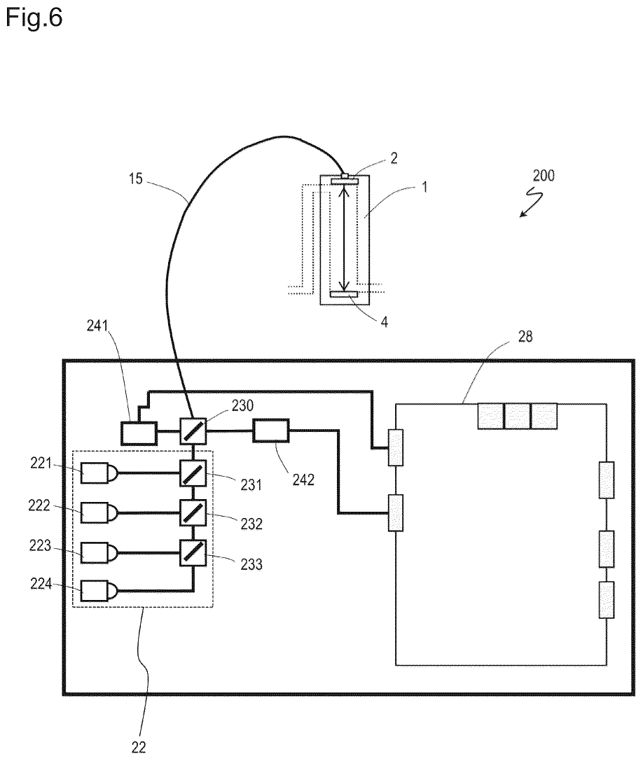

FIG. 6 illustrates another embodiment of the concentration measurement device 200. In the concentration measurement device 200, the same components as those of the concentration measurement device 100 described above are denoted by the same reference numerals, and detailed description thereof may be omitted.

In the concentration measurement device 200, a single common optical fiber cable is used as the transmission member 15. The optical fiber cable guides the light from the light source 22 into the measurement cell 1 via the window 2, receives the light reflected by the reflective member 4 of the measurement cell 1, and guides the light to the photodetector 241 via a beam splitter 230. The beam splitter 230 may also cause a portion of the light from the light source 22 to be incident in the reference photodetector 242.

In the concentration measurement device 200, the light source 22 includes the first light emitting element 221, the second light emitting element 222, a third light emitting element 223, and a fourth light emitting element 224, which are LEDs for emitting lights of differing wavelengths. Lights of multiple wavelengths emitted from the light emitting elements 221 to 224 are combined by WDM (wavelength division multiplexing) multiplexers 231, 232, and 233, and the combined light is incident on the measurement cell 1. As described above, the light source 22 may be configured by using three or more light emitting elements. However, it is not always necessary to generate the light from the light source using all the light emitting elements, and an arbitrary number of light emitting elements may be driven to generate the light from the light source.

Same as in the concentration measurement device 100 shown in FIG. 1, in the concentration measurement device 200, an abnormality in the optical system can be detected by referring to the output of the photodetector 241 while lights being immitted from a plurality of light emitting elements simultaneously. Further, it is also possible to detect abnormality of the light emitting element or the light receiving element by also referring to the output of the reference photodetector 242.

While the concentration measurement device according to the embodiments of the present invention has been described above, the present invention is not limited to the above embodiment, and various changes can be made without departing from the spirit of the present invention. For example, a configuration may be used in which reflective members are provided at both ends of the measurement cell, and light is reciprocated multiple times in measurement cell 1.

### INDUSTRIAL APPLICABILITY

The concentration measurement device and the abnormality detection method thereof according to the embodiments of the present invention are used for semiconductor manufacturing equipment and the like and are suitably used as the concentration measurement device and the abnormality detection method thereof for measuring concentrations of various fluids.

### REFERENCE SIGNS LIST

1 Measurement cell
2 Window
3 Collimator
4 Reflective member
5 Pressure sensor
6 Temperature sensor
10 Fluid unit
11, 12 Optical fiber
13, 14 Optical connector
15 Transmission member
20 Electrical unit
22 Light source
221 First light emitting element
222 Second light emitting element
241 Photodetector
242 Reference photodetector
28 Control circuit
100 Concentration measurement device

1. A concentration measurement device comprising:
an electrical unit including a light source having a plurality of light emitting elements for emitting lights of mutually different wavelengths and a photodetector; a fluid unit having a measurement cell; a transmission member connecting the electrical unit and the fluid unit; and a control circuit connected to the light source and the photodetector, the concentration measurement device being configured to measure a concentration of a fluid in the measurement cell by using the photodetector to detect a light incident on the measurement cell from the light source, and emitted from the measurement cell, wherein
the control circuit is configured to detect existence of an abnormality in an optical system including the light source, the transmission member, and the photodetector, based on an intensity of light emitted from the plurality of light emitting elements and an output of the photodetector.

2. The concentration measurement device according to claim 1, configured so as to turn off the plurality of light emitting elements when an abnormality is detected in the optical system, and to issue an alert to a user.

3. The concentration measurement device according to claim 1, wherein at least one of the lights emitted from the plurality of light emitting elements is ultraviolet light having a wavelength of 200-400 nm.

4. The concentration measurement device according to claim 1, wherein
the electrical unit further includes a reference photodetector for receiving a portion of the light from the light source before the light is incident on the transmission member, and the control circuit is configured to detect existence of the abnormality based on the intensity of the light emitted from the plurality of light emitting elements, the output of the photodetector, and an output of the reference photodetector.

5. The concentration measurement device according to claim 4, wherein the light source includes two light emitting elements, one of the two light emitting elements is arranged to face the reference photodetector with a half mirror disposed in an inclined manner sandwiched therebetween, and the other one of the two light emitting elements is arranged to face the half mirror but not to face the reference photodetector.

6. The concentration measurement device according to claim 1, wherein the transmission member includes a first optical fiber cable for guiding the light from the light source to the measurement cell, and a second optical fiber cable for guiding the light emitted from the measurement cell to the photodetector.

7. An abnormality detection method for a concentration measurement device comprising: an electrical unit including a light source having a plurality of light emitting elements for emitting lights of mutually different wavelengths and a photodetector; a fluid unit having a measurement cell; a transmission member connecting the electrical unit and the fluid unit; and a control circuit connected to the light source and the photodetector, wherein a concentration of the fluid in the measurement cell is measured by using the photodetector to detect the light incident on the measurement cell from the light source and emitted from the measurement cell, the method comprising:
a step of emitting lights of different wavelengths from the plurality of light emitting elements;
a step of measuring an intensity of a light received by the photodetector; and
a step of detecting existence of abnormality in an optical system containing the light source, the transmission member, and the photodetector by comparing the intensity of the light emitted from the plurality of light emitting elements with the intensity of the light received by the photodetector.

8. The abnormality detection method for the concentration measurement device according to claim 7, wherein the light source is constituted by two light emitting elements of a first light emitting element and a second light emitting element; the electrical unit further includes a reference photodetector for receiving a part of the light from the plurality of light emitting elements before the light is incident on the transmission member,
the abnormality detection method further comprising:
a step of determining an occurrence of an optical attenuation abnormality in the optical system, when a result obtained by subtracting a light intensity of the first light emitting element from a light intensity of the first light emitting element detected by the photodetector and a result obtained by subtracting a light intensity of the second light emitting element from a light intensity of the second light emitting element detected by the photodetector is less than or equal to a threshold value, and a result obtained by subtracting the light intensity of the first light emitting element from a light intensity of the first light emitting element detected by the reference photodetector and a result obtained by subtracting the light intensity of the second light emitting element from the light intensity of the second light emitting element detected by the photodetector is less than or equal to a threshold value;
a step of determining an occurrence of an abnormality in the photodetector, when a result obtained by subtracting the light intensity of the first light emitting element from the light intensity of the first light emitting element detected by the photodetector is less than or equal to a threshold value, and a result obtained by subtracting the light intensity of the second light emitting element from the light intensity of the second light emitting element detected by the photodetector is less than or equal to a threshold value;
a step of determining an occurrence of an abnormality in the first light emitting element, when a result obtained by subtracting the light intensity of the first light emitting element from the light intensity of the first light emitting element detected by the photodetector is less than or equal to a threshold value, and a result obtained by subtracting the light intensity of the first light emitting element from the light intensity of the first light emitting element detected by the reference photodetector is less than or equal to a threshold value;
a step of determining an occurrence of an abnormality in the second light emitting element, when a result obtained by subtracting the light intensity of the second light emitting element from the light intensity of the second light emitting element detected by the photodetector is less than or equal to a threshold value, and a result obtained by subtracting the light intensity of the second light emitting element from the light intensity of the second light emitting element detected by the reference photodetector is less than or equal to a threshold value; and
a step of determining an occurrence of an abnormality in the reference photodetector, when a result obtained by subtracting the light intensity of the first light emitting element from the light intensity of the first light emitting element detected by the reference photodetector is less than or equal to a threshold value, and a result obtained by subtracting the light intensity of the second light emitting element from the light intensity of the second light emitting element detected by the reference photodetector is less than or equal to a threshold value.
